(19) United States
(12) Patent Application Publication
(10) Pub. No.: US 2015/0233174 A1
(43) Pub. Date: Aug. 20, 2015

(54) METHOD AND APPARATUS FOR SPACERS FOR INTER-PANE CAVITY OF VACUUM INSULATING GLASS UNITS AND VACUUM INSULATING GLASS UNITS INCORPORATING SAME

(71) Applicant: EVERSEALED WINDOWS, INC., Evergreen, CO (US)

(72) Inventor: DAVID H. STARK, EVERGREEN, CO (US)

(21) Appl. No.: 14/622,858

(22) Filed: Feb. 14, 2015

Related U.S. Application Data
(60) Provisional application No. 61/940,268, filed on Feb. 14, 2014.

(51) Int. Cl. E06B 3/677

(52) U.S. Cl. CPC E06B 3/677

(57) ABSTRACT

A vacuum insulating glass unit comprises a first lite of transparent material having an inner surface and a periphery and a second lite of transparent material having an inner surface and a periphery. The second lite is spaced apart from the first lite to define a cavity between the opposing inner surfaces. An edge seal assembly hermetically joins the peripheries continuously around the cavity. A plurality of stand-offs are disposed within the cavity, each stand-off having a filament body having a rectangular cross-section including a relatively flat top surface, a relatively flat bottom surface, and relatively flat sides. The filament body has a curved shape, when viewed perpendicular to the inner surfaces. At least one adherence point on one of the top surface or bottom surface of the filament body is affixed to at least one of the inner surfaces of the adjacent first or second lites.

### CROSS-REFERENCE TO RELATED APPLICATIONS

This application claims the benefit of U.S. Provisional Application No. 61/940,268, filed on Feb. 14, 2014, entitled METHOD AND APPARATUS FOR SPACERS FOR INTER-PANE CAVITY OF VACUUM INSULATING GLASS UNITS AND VACUUM INSULATING GLASS UNITS INCORPORATING SAME (Atty. Dkt. No. STRK-32025), which is hereby incorporated by reference.

### TECHNICAL FIELD

The current invention relates to multi-pane vacuum insulating glass units (“VIGUs” or “VIGs”) for use in fenestration applications (e.g., windows and doors for buildings); windows for transportation vehicles (e.g., buses, trucks, automobiles, planes, trains, ships); solar collector panels; supermarket refrigeration systems; insulating glass units for beverage vending machines; and any other application where a VIGU might be used.

### BACKGROUND

Vacuum insulated glass units (“VIGUs”) are of interest for window applications because of their extremely high thermal insulating properties, with center-of-glass R values as high as R 13 or more. A VIGU may comprise two spaced-apart glass sheets, between which are disposed a series of stand-offs. A sealing system may include compliant members and/or rigid members disposed around the edges of the glass sheets and hermetically bonded thereto to form a hermetically sealed cavity between the glass sheets. The cavity of the VIGU may then be evacuated to a pressure of 1×10⁻³ torr or below. The stand-offs in the cavity must allow evacuation of the atmosphere within the cavity.

Once the VIGU is evacuated, the glass sheets are subject to one atmosphere of pressure on both sides of the unit. The role of the stand-offs between the glass sheets (lites) is to prevent the lites from bowing inward and touching each other under this pressure, as direct physical contact between the sheets will result in a thermal short that degrades the windows insulating performance. Further, the high stresses pressing inwards on the glass can result in glass breakage.

The stand-offs themselves also create a thermal path between the two lites. Therefore it is particularly advantageous to use as few as stand-offs as possible, with minimum cross-sectional area in contact with the glass. This requirement means that there is intense compressive force placed on each stand-off, and the stand-offs must have a sufficiently high compressive yield strength to accommodate the large loads.

Further, during diurnal cycling of the windows, the outer lite will be exposed to the outside environment, and become relatively hotter and/or colder than the inner lite. This relative expansion/contraction of the outer lite versus the inner lite means that the stand-offs may scrape back and forth across one or both lites during thermal cycling. For VIGUs designed with a flexible edge seal, the stand-offs can travel as much as 0.5 mm during cycling of a 1 m² unit in an extreme climate such as Eli, Nev. Thus, it is critical to ensure that the interface between the stand-off and the glass sufficiently lubricated that the glass or any coating on the glass is not scratched or otherwise damaged during this cycling.

Finally, these stand-offs must be applied to (i.e., positioned on) at least a first glass sheet during VIGU fabrication, where the second sheet is positioned atop the stand-offs before sealing. For stand-offs that adhere poorly to the glass, it becomes difficult to handle the glass after stand-off placement, and this imposes significant restrictions on the manufacturing flow of the VIGU. If the stand-offs are not bonded to the VIGU, the window should not be moved before vacuum is applied (after which the pressure of the glass on the stand-offs hold them in place). Any technology for bonding the stand-offs to glass requires that a completely non-outgassing material be used for the stand-off and its lubricant coating, and that a very simple manufacturing flow be employed. As a result, in the literature there is no simple means suggested for bonding stand-offs to glass prior to subsequent handling.

It is the purpose of this invention to describe a stand-off construction and means for manufacturing stand-offs and VIGUs with stand-offs that resolve many of the aforementioned problems.

### SUMMARY

In one aspect, a vacuum insulating glass unit (VIGU) comprises a first lite of a first transparent material having a first inner surface and a first periphery and a second lite of a second transparent material having a second inner surface and a second periphery. The second lite is spaced apart from the first lite to define a cavity between the opposing first and second inner surfaces. An edge seal assembly hermetically joins the first periphery to the second periphery continuously around the cavity. A plurality of stand-offs are disposed within the cavity, each stand-off having a filament body, the filament body having a rectangular cross section, when viewed parallel to the first or second inner surface, including a relatively flat top surface, a relatively flat bottom surface, and relatively flat sides. The filament body has a curved shaped, when viewed perpendicular to the first or second inner surface. The stand-off further has at least one adherence point on one of the top surface or bottom surface of the filament body, the at least one adherence point being affixed to at least one of the inner surfaces of the adjacent first or second lites.

In one embodiment, the curved shape of the filament body is “0-shaped” when viewed parallel to the first or second inner surface

In another embodiment, a height of the stand-off at the at least one adherence point, measured perpendicular to the surfaces of the adjacent lites, is less than the height of remaining filament body.

In still another embodiment, all of the adherence points have a total area affixed to the surface of the adjacent lite that is less than 25% of the total surface area of the stand-off contacting that lite.

In yet another embodiment, all of the adherence points have a total area affixed to the surface of the adjacent lite that is less than 10% of the total surface area of the stand-off contacting that lite.

In a further embodiment, the rectangular cross-section of the filament body includes radiused corners.

In another embodiment, the curved shape of the filament body is “C-shaped” when viewed parallel to the first or second inner surface

In still another embodiment, the filament body is coated with one of indium or a tin-indium alloy

In another aspect, a method for vacuum insulating glass unit (VIGU) comprises the steps of providing a first lite of a first transparent material having a first inner surface and a first periphery, and positioning a plurality of stand-offs on the first inner surface within the first periphery. Each stand-off has a filament body, the filament body having a rectangular cross section, when viewed parallel to the first inner surface, including a relatively flat top surface, a relatively flat bottom surface, and relatively flat sides. The filament body has a curved shape, when viewed perpendicular to the first inner surface. Each stand-off further has at least one adherence point on one of the top surface or bottom surface of the filament body. The method further comprises providing a second lite of a second transparent material having a second inner surface and a second periphery, the second lite being spaced apart from the first lite to define a cavity between the opposing first and second inner surfaces, adhering the at least one adherence point on each of the plurality of stand-offs to at least one of the inner surfaces of the adjacent first or second lites, and hermetically joining an edge seal assembly between the first periphery and the second periphery continuously around the cavity.

In one embodiment, the step of adhering the adherence point on each stand-offs to the inner surface of the adjacent lite includes heating the adherence point using contact heating.

In another embodiment, the step of adhering the adherence point on each stand-offs to the inner surface of the adjacent lite includes heating the adherence point using directed energy.

In still another embodiment, the directed energy for heating the adherence point is a laser beam.

In yet another embodiment, the laser beam is directed at the adherence point through open space.

In a further embodiment, the laser beam is directed at the adherence point through the adjacent lite.

In another embodiment, the filament body of the stand-off is formed into the curved shape before being positioned on the first inner surface or adhered to the inner surface of the adjacent lite.

In yet another embodiment, the filament body of the stand-off is formed into the curved shape after having at least one adherence point affixed to the first inner surface.

### BRIEF DESCRIPTION OF THE DRAWINGS

For a more complete understanding, reference is now made to the following description taken in conjunction with the accompanying Drawings in which:

FIG. 1 illustrates a VIGU in accordance with the prior art;

FIG. 2 illustrates a VIGU in accordance with one aspect of the current invention;

FIG. 3a is a top view of an “O-shaped” stand-off in accordance with one embodiment for use in the VIGU of FIG. 2, the stand-off being disposed on a portion of the lower lite before adherence;

FIG. 3b is a cross-sectional side view of the stand-off and lite of FIG. 3a taken along line 3b-3b of FIG. 3a;

FIG. 3c is a perspective view of the stand-off and lite of FIG. 3a;

FIG. 4a is a top view of the “O-shaped” stand-off of FIG. 3a after adherence to the lower lite;

FIG. 4b is a cross-sectional side view of the stand-off and lite of FIG. 4a taken along line 4b-4b of FIG. 4a;

FIG. 4c is a perspective view of the stand-off and lite of FIG. 4a;

FIG. 5a is a top view of a “C-shaped” stand-off in accordance with another embodiment for use in the VIGU of FIG. 2, the stand-off being disposed on a portion of the lower lite before adherence;

FIG. 5b is a top view of the “C-shaped” stand-off of FIG. 5a disposed on a portion of the lower lite after adherence;

FIG. 5c is a cross-sectional side view of the stand-off and lite of FIG. 5b taken along line 5c-5c of FIG. 5b; and

FIG. 5d is a perspective view of the “C-shaped” stand-off and lite of FIG. 5b after adherence.

### DETAILED DESCRIPTION

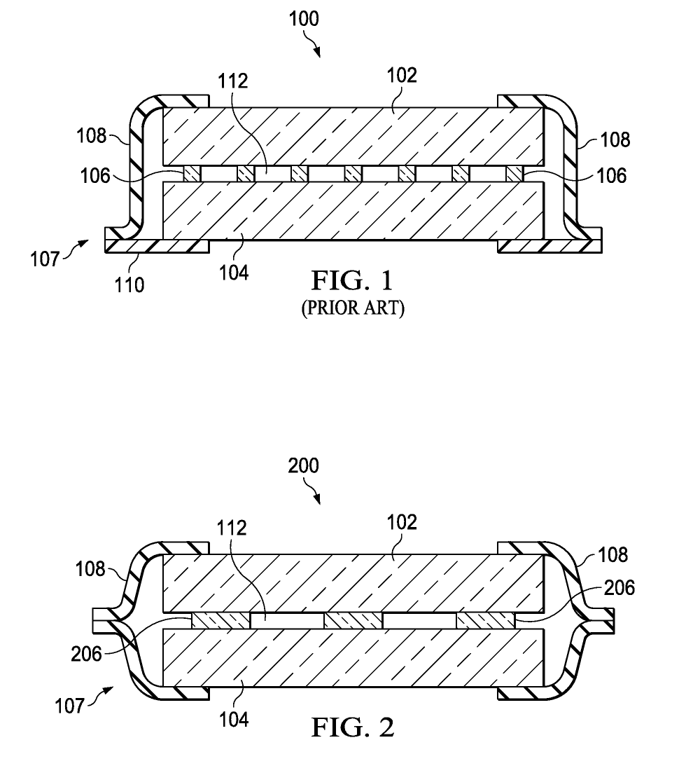

Referring to FIG. 1, there is illustrated a VIGU 100 in accordance with the Prior Art. The VIGU 100 may comprise two spaced-apart glass sheets 102 and 104, between which are disposed a series of stand-offs 106. A sealing system 107 including compliant members 108 and/or rigid members 110 is disposed around the edges of the glass sheets 102, 104 and hermetically bonded thereto to form a hermetically sealed cavity 112 between the glass sheets. The cavity 112 of the VIGU 100 may then be evacuated to a pressure of 1×10⁻³ torr or below. The stand-offs 106 in the cavity 112 must allow evacuation of the atmosphere within the cavity. It will be appreciated that the dimensions of the VIGU, including the dimensions of the sheets, stand-offs, cavity, etc. are not drawn to scale in FIG. 1.

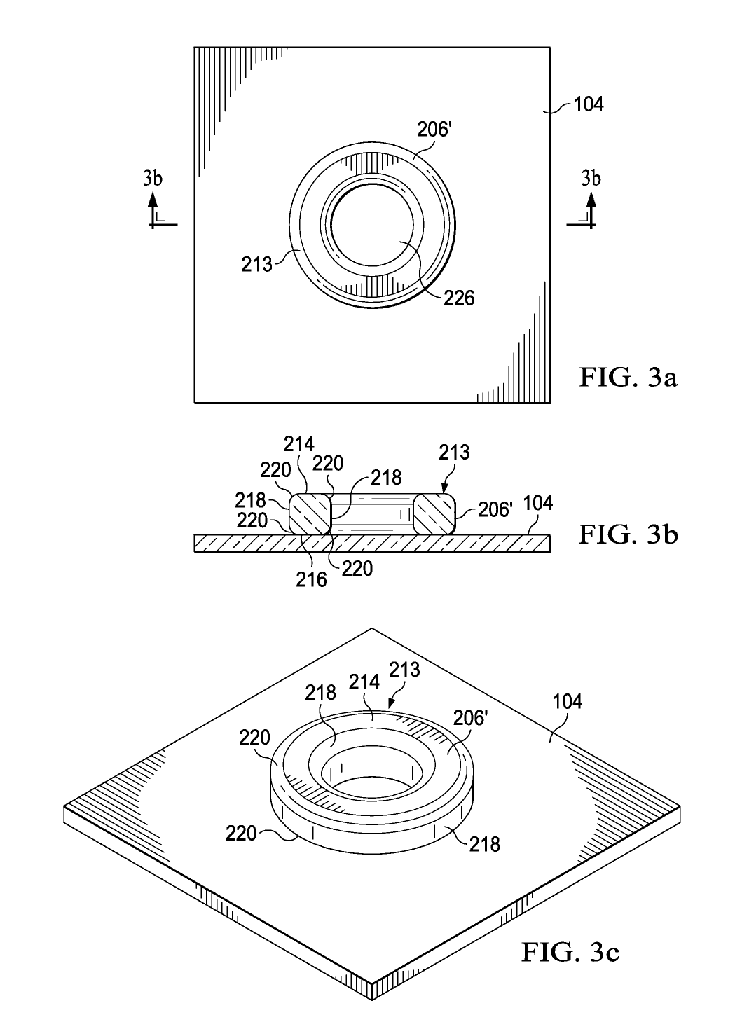

Referring now to FIG. 2, a VIGU is illustrated in accordance with one embodiment. Except as otherwise described, the VIGU 200 may be substantially similar to the Prior Art VIGU 100 previously described. The VIGU 200 may comprise two spaced-apart glass sheets 102 and 104, between which are disposed a series of stand-offs 206 as further described herein. A sealing system 107 including compliant members 108 and/or rigid members 110 (not shown) is disposed around the edges of the glass sheets 102, 104 and hermetically bonded thereto to form a hermetically sealed cavity 112 between the glass sheets. The cavity 112 of the VIGU 200 may then be evacuated to a pressure of 1×10⁻³ torr or below. The stand-offs 206 in the cavity 112 must allow evacuation of the atmosphere within the cavity. It will be appreciated that the dimensions of the VIGU 200, including the dimensions of the sheets, stand-offs, cavity, etc. are not drawn to scale in FIG. 2

In the illustrated embodiment of this invention, the stand-offs 206 for the VIGU 200 are created as a glass filament or glass ribbon having a rectangular cross section. The filament may have a substantially square cross-section area with some or all of the corners being rounded (i.e., being a radius or containing a radius).

In another embodiment, the filament's rectangular cross section is not square, but rather, its width is wider than its height. The width dimension (“Y”) of the filament may be the length of the part of the cross-section of the filament that is positioned parallel to the surface of the glass sheet, e.g., sheet 104, onto which the filament is eventually placed. The height dimension (“X”) of the filament may be the length of the part of the cross-section of the filament that is positioned perpendicular to the surface of the glass 104 onto which the filament is placed.

The aspect ratio of a rectangular stand-off is the ratio of the height X of the standoff to the width Y of the standoff. The presence or absence of radiused corners on a stand-off does not affect its aspect ratio.

In yet another embodiment of the invention, a stand-off 206 for a VIGU 200 is created using a low-friction coating with a preferred but not required melting point≧265° C. In one such embodiment, the coating is composed of one of the many chemical composition of silanes or silozanes. But other low coefficient-of-friction (“COF”) coating may also be deposited on and/or into the surfaces of the glass filaments.

In another embodiment, stand-offs 206 are provided with a low COF coating including indium having a melting point less than 265° C. To form stand-offs 206 having such a low COF coating, indium may be applied to a spool of glass filament by running the filament from one reel onto another as the glass filament is submersed in one of: (a) an electroless solution plating bath of indium; (b) a molten bath of indium; (c) a solder fountain of indium; (d) a molten ultrasonic energy-agitated bath of indium; or (e) by other known means of creating a layer of indium onto the surface of the glass filaments.

In other embodiments similar to that just described, other low COF metallic coatings that may be provided on stand-offs 206 include, but are not limited to, metal alloys. One example is a tin-indium metal alloy.

In other embodiments, stand-offs 206 are provided with thin films of low melting temperature alloys, particularly those containing indium or bismuth, which anchor the stand-offs effectively to glass yet provide for good lubricity. These properties are understood to result from the particular mechanism for friction reduction in these films: the materials themselves are actually quite adherent, but when they are coated to conform to a first rough surface, they will have very little total surface area in contact with any other surface that they are placed against. Further, because these low melting alloys have low shear strength, they may fail cohesively when rubbed, allowing for easy sliding. This combination of low contact area and low strength may provide the stand-off 206 with an exemplary coefficient of friction of 0.3 or less.

In still other embodiments, the shape of the glass filaments or ribbons that are adhered to one of the two cavity-facing surfaces of the pairs of glass lites of the VIG will be formed to be compliant (i.e., flexible with our without exposure to changes in its temperature).

Depending on how and where on the glass ribbon standoffs that the standoffs are adhered to the surface of the glass lite, e.g., sheet 104, the standoffs 206 may be very complaint to mechanical forces including changes in their temperatures and differential movements of the two panes of glass 102, 104 of which the stand-offs maintain separation. The principal design goal for the standoffs 206 is that the formed standoff's dimensions be allowed to change in size due to changes in their temperature. Thus, in conjunction with their low-COF coating that allow the non-adhered sections on the standoffs 206 to slide or move relative to both pairs or lites 102, 104 of the VIGUs, the glass standoffs where not intentionally or unintentionally adhered to either lite may expand or contract with changes in their temperature.

Many compliant shapes are known. Shapes for the glass ribbon standoffs 206 include, but are not limited to circles, rounded shapes such as the English alphabet letters “C”, “J”, “O” and “S” and “U” as well as English alphabet letters that do not have one or more straight segments, including the letters “B”, “D”, “E”, “H” “K”, “L”, “M”, “N”, “P”, “R”, “T”, “V”, “W”, “X”, “Y” and “Z”. However, the preferred shapes are round in area as they provide the greatest ratio surface area of the stand-off 206 itself to the overall or total area which they occupy on the surface of the glass 102, 104 with few exceptions, such as straight lines. Thus, either the a round shape such as the an unbroken circle adhered to the surface of the glass (or coating on the glass) in one spot or two opposite sides of the circle, or a rounded letter “C” which is a circle with an opening it its circumference, are the preferred shapes for the glass filament or glass ribbon standoffs. In the case of the rounded letter “C”, it would be adhered to the surface of the glass or the coating on the glass at the two ends of the letter “C”.

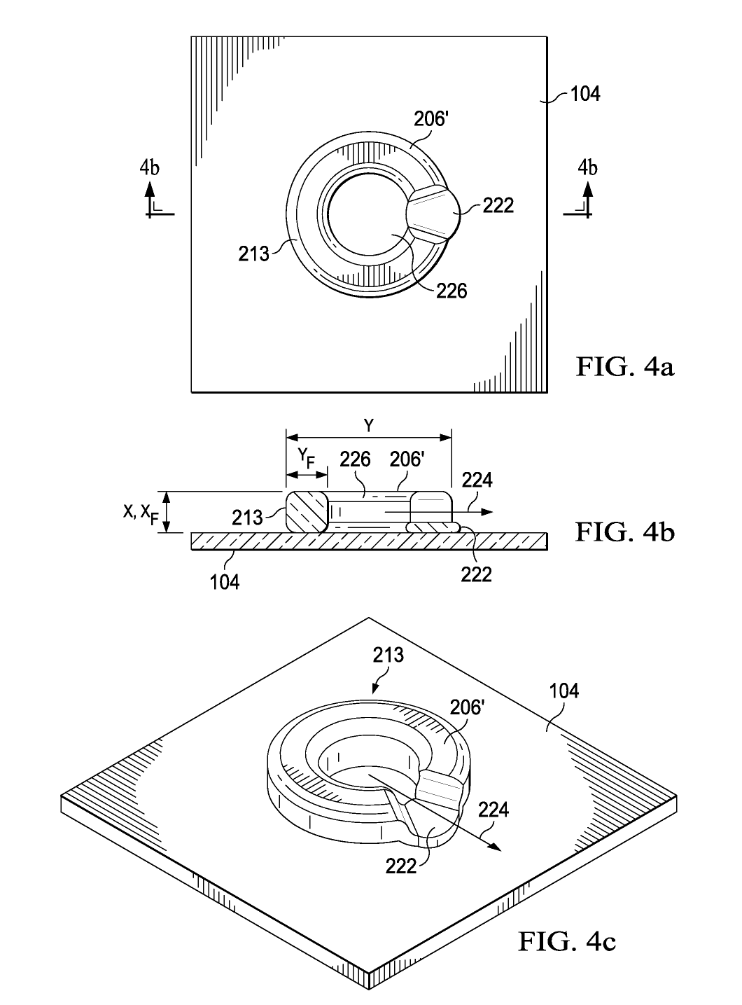

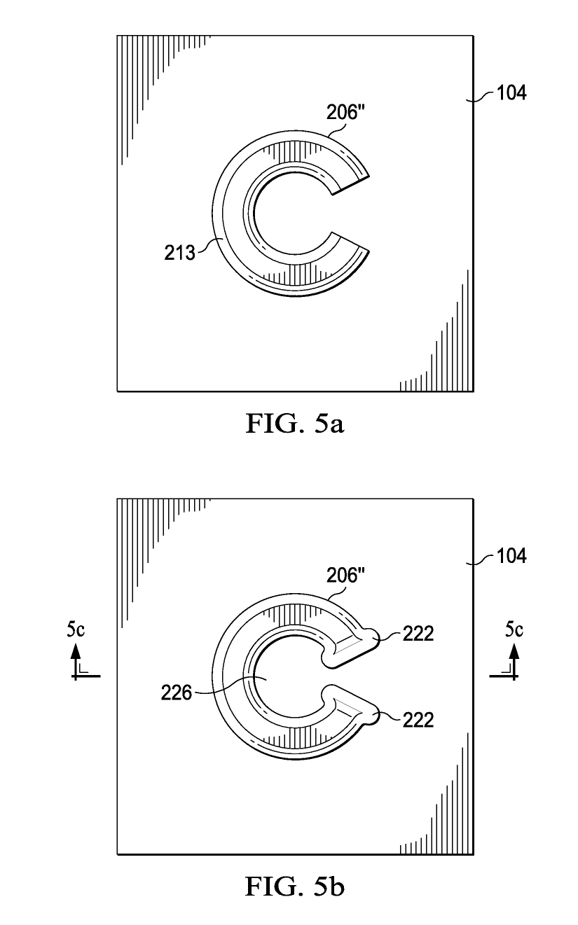

Referring now to FIGS. 3a, 3b and 3c, there is illustrated an “O-shaped” stand-off 206′ in accordance with one embodiment for use in the VIGU of FIG. 2. Specifically, FIG. 3a is a top view (plan view), FIG. 3b is a cross-sectional side view taken along line 3b-3b of FIG. 3a and FIG. 3c is a perspective view, all showing the stand-off 206′ prior to adherence to the lite 104. As best seen in FIG. 3b, the filament body 213 of the illustrated “O-shaped” standoff 206′ has a substantially square cross-section, with a substantially flat top 214, a substantially flat bottom 216 and substantially flat sides 218, however, the corners 220 are radiused. A square cross-section means the filament body 213 has a perpendicular-to-lite dimension, “X_{F}”, and a parallel-to-lite dimension, “Y_{F}”, (see FIG. 4b) that are approximately equal. In other embodiments, other rectangular cross-sections may be used for the filament body 213.

Referring now to FIGS. 4a, 4b and 4c, the “O-shaped” stand-off 206′ of FIG. 3a is shown after adherence to the lower lite 104. Specifically, FIG. 4 is a top view, FIG. 4b is a cross-sectional side view taken along line 4b-4b of FIG. 4a and FIG. 4c is a perspective view. In the illustrated embodiment, the stand-off 206′ is attached to the lower lite 104 at a single adherence point or bond point 222. In other embodiments, multiple bond points may be used. Preferably, the bond point(s) affix only a small percentage of the total lite-contacting surface area of the top 214 or bottom 216 of the stand-off 206′ to the surface of the respective lite 102, 104. In some embodiments, the total area of the bond points 222 affixed to the surface of a lite 102, 104 for each stand-off 206′ is less than 25% of the total surface area of that stand-off contacting that lite. In other embodiments, the total area of the bond points 222 affixed to the surface of a lite 102, 104 for each stand-off 206′ is less than 10% of the total surface area of that stand-off contacting that lite. This structure maintains the general position of the stand-off 206 on the lite 102, 104, but allows the un-affixed portions of the stand-off to “float”, or move, relative to the lite to accommodate relative movement between the lites.

At the bond point 222, the filament body 213 of the stand-off 206′ may be partially flattened. This flattening may be caused by localized heating of the stand-off 206′, e.g., by the application of contact heating or by directed energy such as a laser beam, with or without the application of localized pressure. In the case of heating with directed energy, including heating with a laser beam, in some embodiments the heating energy may be directed onto the bond point on the stand-off through open space, whereas in other embodiments, the heating energy may be directed onto the bond point through the adjacent lite. The heating (and pressure, if applicable) may cause the filament body 213 of the stand-off 206′ and/or the adjacent area of the lite 104 to soften or melt when the bond point 222 becomes affixed to the surface of the lite (or lite coating). The flattening of the filament body 213 creates a channel or passageway 224 through the wall of the stand-off 206′ allowing the atmosphere within the interior 226 of the stand-off to be evacuated even when the stand-off is contacting both lites 102 and 104.

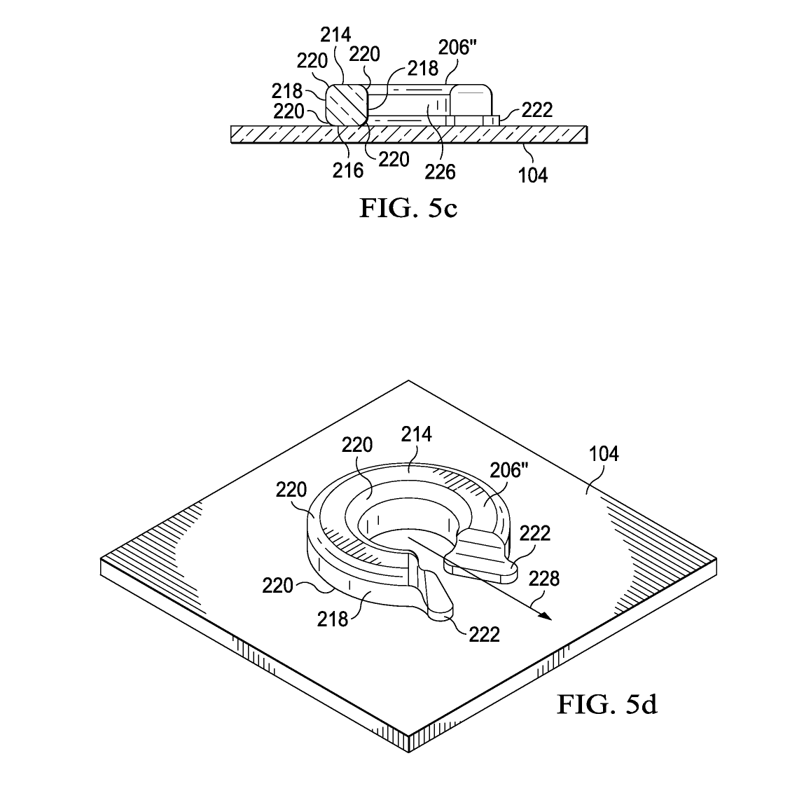

Referring now to FIGS. 5a, 5b, 5c and 5d, there is illustrated a “C-shaped” stand-off 206″ in accordance with another embodiment for use in the VIGU of FIG. 2. Specifically, FIG. 5a is a top view of the stand-off 206″ prior to adherence to the lower lite 104, FIG. 5b is a top view of the stand-off after adherence, FIG. 5c is a cross-sectional side view taken along line 5c-5c of FIG. 5b and FIG. 5d is a perspective view. As best seen in FIG. 5c, the filament body 213 of the “C-shaped” standoff 206″ has a substantially square cross-section similar to that of standoff 206′ just described, with a substantially flat top 214, a substantially flat bottom 216, substantially flat sides 218 and radiused corners 220.

The “C-shaped” stand-off 206″ of FIG. 5b may be attached to the lite 104 with one or more bond points 222. In the illustrated embodiment, two bond points 222 are used, one at each end of the body filament 213. Preferably, the bond point(s) affix only a small percentage of the total lite-contacting surface area of the top 214 or bottom 216 of the stand-off 206″ to the surface of the respective lite 102, 104. In some embodiments, the total area of the bond points 222 affixed to the surface of a lite 102, 104 for each stand-off 206″ is less than 25% of the total surface area of that stand-off contacting that lite. In other embodiments, the total area of the bond points 222 affixed to the surface of a lite 102, 104 for each stand-off 206″ is less than 10% of the total surface area of that stand-off contacting that lite.

In the illustrated embodiment, the stand-off 206″ is partially flattened at the bond points 222. As previously described, this flattening may be caused by localized heating of the stand-off 206″ with or without the application of localized pressure. In other embodiments, however, the “C-shaped” stand-off 206″ may be adhered to the lite 104 without flattening or partial flattening. In contrast to the “O-shaped” stand-off 206′, the “C-shaped” stand-off 206″ does not require flattening to produce a channel or passageway 226 from the interior 226 of the stand-off to the exterior. Thus, a passageway 228 is present even if the stand-off 206″ is adhered with no flattening.

Several different types or sources of light (i.e., wavelengths of light) may shine on, or interact with the glass standoffs 206 in the VIGU 200. These sources include, but are not limited to incandescent, fluorescent, LED, LCD, plasma and solar light sources. In some incidents, tints such as films and coating may be involved. In every instance, the angles of incidence may not be fixed by may be moving, such as is almost always the case with solar light sources. Thus if nothing is done, undesirable optical effects could occur which could be annoying to individuals looking at or through the VIGUs.

In another aspect, glass standoffs 206 are made or modified to be non-reflective. Two methods to accomplish non-reflectivity are to coat the glass (or other material) of the stand-offs 206 with a non-reflective coating and/or to add a dye (or tint or other coloring agent) to the glass during its fabrication to make it opaque enough or to embellish it with anti-reflective (“A/R”) properties. As it is desired that the surface of the glass of the stand-off 206 have a low COF against the surface of the glass or glass coating to which it is not intentionally adhered (e.g., sheet 102) to during assembly of the VIGU 200, the low COF coating or coatings may be applied to the glass standoff material after any A/R coatings or dyes are applied to or into the glass filaments or ribbons.

In another aspect, stand-offs 206 are adhered at one or more places along the standoff itself onto the surface of the glass or glass coating, e.g., the inner surface of sheet 104. The adhering may be accomplished by methods including, but are not limited to: (a) using a modified wedge- or ribbon wedge-bonder such as is known to those skilled in the art of semiconductor packaging, but further modifying the bonding mechanism by mounting it on a moving mechanism including but not limited to a robotic arm or gantry system in an appropriate fashion to accommodate and be used on a piece of glass much larger than the small parts, packages and substrates used in the semiconductor industry; (b) one or more lasers of the appropriate wavelengths, used with or without mechanical mechanisms to place and/or pull apart the glass of the stand-off at the last bonding location; (c) heating tooling such as electrical resistance heating elements (e.g., a soldering iron) with or without inclusion of ultrasonic energy; or (d) other heating and adherence tools and mechanisms.

In each instance of adherence to the surface of the glass of the VIGU or a coating on the surface of the glass 104, the stand-off filament or ribbon glass may be supplied by its producer on spools or reels. In order to place it onto the glass or coating surface, the standoff ribbon may be fed though a guide mechanism such as a bonder's capillary tube. In some embodiments, the compliant shape of the standoff 206 is created during the placement of the glass ribbon onto the VIGU's cavity-facing glass surface or coated glass surface 102 or 104; as such the placement mechanism must be capable of forming the compliant shape while keeping at least one of the two Y-axis surfaces (e.g., tops 214 and bottoms 216) of the ribbon parallel to the glass or coated glass surface, i.e., the ribbon stand-off placement mechanism must sufficiently prevent twisting of the ribbon such that once the VIGU 200 is assembled and the glass standoffs 206 are in between a pair of glass lites 102 and 104, the standoffs are all flat and their Y-dimensions or surfaces (e.g., tops 214 and bottoms 216) are all parallel to the surfaces (not perimeters) of the lites and their X-dimensions or surfaces (e.g., sides 218) are all perpendicular to the surfaces) of the lites.

In some aspects, the glass filament or glass ribbon standoffs 206 for this application are fabricated into rounded shapes prior to placement and then adherence onto one surface of one glass lite or onto the coated surface of one glass lite. I.e., they are pre-fabricated and supplied as a completed shape (such as, but not limited to a circle or rounded letter “C”) to the stand-off attachment process of the VIG's assembly procedure. Then after appropriate placement onto the surface of one lite, e.g., sheet 104, one of the adherence methods described above may be employed to adhere the pre-fabricated standoffs 206 onto the surface of the glass or coated glass lite 102 or 104.

In some embodiments, when a coating or coating to be applied to the glass filament or ribbon for A/R, low COF or other purposes, the coating may be removed in the areas where the glass filament 206 is to be adhered to the glass 102 or 104. Many processes for this removal step may be used including, but not limited to, mechanical abrasive remove methods, laser ablation and chemical removal processes.

In still other embodiments, the process of adhering the glass filament standoff 206 onto the lite 102 and/or 104 of the VIGU 200 reduces the cross-section height of the stand-off 206 where the adherence by heat, soldering, ultrasonic scrubbing or another appropriate method is used. The cross-section height is the X-axis dimension of the stand-off (i.e., X or X_{F}).

The glass used to make the filament or ribbon glass stand-offs 206 may be a variety of types of glass. The glass lites 102, 104 of a VIGU 200 are typically made from soda-lime float glass. Although basically generic, the coefficient of thermal expansion of the soda-lime glass can vary among geographic regions of the globe due to differences in the sand used to make the soda-lime glass. The glass filaments used for the stand-offs 206 could be made from local, regional or distant-region soda-lime glass.

A preferred glass for producing the filament or ribbon glass stand-offs 206 is a borosilicate glass. This glass is also sometimes called a sodium borosilicate glass. Compared to soda-lime glass, borosilicate glasses have almost one third the coefficient of thermal expansion (“CTE”) of soda lime glasses which make the borosilicate glasses more dimensionally stable. In addition, borosilicate's lower CTEs also help to make them less prone to stress caused by them expansion and less vulnerable to cracking from thermal shock.

It should be noted that the filament or ribbon-shaped material used to make the stand-offs 206 for VIGUs 200 need not be made of glass or quartz glass. However, glass has a lower thermal conductivity than almost any other non-outgassing material, which is a principal advantage for using glass standoffs that come in physical contact with the interior or cavity-facing surfaces of the pairs of glass lites of a VIGU.

Although the preferred embodiment has been described in detail, it should be understood that various changes, substitutions and alterations can be made therein without departing from the spirit and scope of the invention as defined by the appended claims.

What is claimed is:

1. A vacuum insulating glass unit (VIGU) comprising:
a first lite of a first transparent material having a first inner surface and a first periphery;
a second lite of a second transparent material having a second inner surface and a second periphery, the second lite being spaced apart from the first lite to define a cavity between the opposing first and second inner surfaces;
an edge seal assembly hermetically joining the first periphery to the second periphery continuously around the cavity; and
a plurality of stand-offs disposed within the cavity, each stand-off having
a filament body,
the filament body having a rectangular cross section, when viewed parallel to the first or second inner surface, including a relatively flat top surface, a relatively flat bottom surface, and relatively flat sides, and
the filament body having a curved shape, when viewed perpendicular to the first or second inner surface; and
at least one adherence point on one of the top surface or bottom surface of the filament body, the at least one adherence point being affixed to at least one of the inner surfaces of the adjacent first or second lites.

2. A VIGU in accordance with claim 1, wherein the curved shape of the filament body is “O-shaped” when viewed parallel to the first or second inner surface

3. A VIGU in accordance with claim 2, wherein a height of the stand-off at the at least one adherence point, measured perpendicular to the surfaces of the adjacent lites, is less than the height of remaining filament body.

4. A VIGU in accordance with claim 2, wherein all of the adherence points have a total area affixed to the surface of the adjacent lite that is less than 25% of the total surface area of the stand-off contacting that lite.

5. A VIGU in accordance with claim 4, wherein all of the adherence points have a total area affixed to the surface of the adjacent lite that is less than 10% of the total surface area of the stand-off contacting that lite.

6. A VIGU in accordance with claim 1, wherein the rectangular cross-section of the filament body includes radiused corners.

7. A VIGU in accordance with claim 1, wherein the curved shape of the filament body is “C-shaped” when viewed parallel to the first or second inner surface

8. A VIGU in accordance with claim 1, wherein the filament body is coated with one of indium or a tin-indium alloy.

9. A method for vacuum insulating glass unit (VIGU), the method comprising the following steps:
providing a first lite of a first transparent material having a first inner surface and a first periphery;
positioning a plurality of stand-offs on the first inner surface within the first periphery, each stand-off having
a filament body,
the filament body having a rectangular cross section, when viewed parallel to the first inner surface, including a relatively flat top surface, a relatively flat bottom surface, and relatively flat sides, and
the filament body having a curved shape, when viewed perpendicular to the first inner surface; and
at least one adherence point on one of the top surface or bottom surface of the filament body,
providing a second lite of a second transparent material having a second inner surface and a second periphery, the second lite being spaced apart from the first lite to define a cavity between the opposing first and second inner surfaces;
adhering the at least one adherence point on each of the plurality of stand-offs to at least one of the inner surfaces of the adjacent first or second lites; and
hermetically joining an edge seal assembly between the first periphery and the second periphery continuously around the cavity.

10. A method in accordance with claim 9, wherein the step of adhering the adherence point on each stand-offs to the inner surface of the adjacent lite includes heating the adherence point using contact heating.

11. A method in accordance with claim 9, wherein the step of adhering the adherence point on each stand-offs to the inner surface of the adjacent lite includes heating the adherence point using directed energy.

12. A method in accordance with claim 11, wherein the directed energy for heating the adherence point is a laser beam.

13. A method in accordance with claim 12, wherein the laser beam is directed at the adherence point through open space.

14. A method in accordance with claim 12, wherein the laser beam is directed at the adherence point through the adjacent lite.

15. A method in accordance with claim 9, wherein the filament body of the stand-off is formed into the curved shape before being positioned on the first inner surface or adhered to the inner surface of the adjacent lite.

16. A method in accordance with claim 9, wherein the filament body of the stand-off is formed into the curved shape after having at least one adherence point affixed to the first inner surface.
